(19) United States
(12) Patent Application Publication
(10) Pub. No.: US 2022/0200958 A1
(43) Pub. Date: Jun. 23, 2022

(54) NETWORK SECURITY CONFIGURATION OF IMAGE FORMING APPARATUS

(71) Applicant: Hewlett-Packard Development Company, L.P., Spring, TX (US)

(72) Inventor: Hyun-wook PARK, Seongnam-si (KR)

(21) Appl. No.: 17/606,151

(22) PCT Filed: May 19, 2020
(86) PCT No.: PCT/US2020/033574

§ 371 Date: Oct. 25, 2021

(30) Foreign Application Priority Data
Nov. 27, 2019 (KR) 10-2019-0154340

(51) Int. Cl. H04L 9/40; H04L 61/5007

(52) U.S. Cl. CPC H04L 63/0236; H04L 63/20; H04L 61/2007

(57) ABSTRACT

An example network security setting method may include receiving a server discovery message, broadcasting a server offer message in response to the server discovery message, receiving an internet protocol (IP) address allocation request from an image forming device that has received the server offer message, and transmitting an IP address and an IP security policy to the image forming device in response to the IP address allocation request.

### BACKGROUND OF THE INVENTION

An image forming device is a device the executes generation, printing, receiving, transmission, or the like of image data. Representative examples of an image forming device include a printer, a scanner, a copier, a fax machine, and a multifunction printer that incorporates these functions. The image forming device executes internet protocol (IP) security based on an IP address of a network packet received through a network.

### BRIEF DESCRIPTION OF THE DRAWINGS

Various examples will be described below by referring to the following figures.

FIG. 1 is a block diagram of a network according to an example.

FIG. 2 is a block diagram of an image forming device according to an example.

FIG. 3 is a block diagram of a software function module of an image forming device according to an example.

FIG. 4 is a flowchart illustrating a process of setting an internet protocol (IP) security policy according to an example.

FIG. 5 shows a packet of a response message of a dynamic host configuration protocol (DHCP) server according to an example.

FIG. 6 shows a packet of a DHCP request message of an image forming device according to an example.

FIG. 7 shows a packet of a response message of a DHCP server to which an IP security method is applied according to an example.

FIG. 8 is a flowchart illustrating an IP security policy management method of an image forming device according to an example.

### DETAILED DESCRIPTION OF EXAMPLES

As those skilled in the art will realize, the following described examples may be modified in various different ways, all without departing from the spirit or scope of the present invention. In the following description, parts that are not relevant to the description will be omitted, and the same elements or equivalents are referred to by the same reference numerals throughout the specification.

In addition, unless explicitly described to the contrary, the word “comprise” and variations such as “comprises” or “comprising” will be understood to imply the inclusion of stated elements but not the exclusion of any other elements.

In addition, the terms “-er”, “-or”, and “module” described herein refer to units for processing at least one function or operation, and can be implemented by hardware components, software components, or combinations thereof.

A server and a device described herein are composed of hardware including at least one processor, a memory, a communication device, or the like, and a program executed in combination with the hardware is stored in a designated place. The hardware has the configuration and performance to implement example methods as described herein. The program includes instructions that implement example methods of operation as described herein with reference to the drawings, and the instructions are to executed in combination with hardware such as a processor and a memory.

In the following description, the term “transmission or provision” may include not only direct transmission or provision, but also indirect transmission or provision through other devices or indirect routes.

In the following description, expressions described in the singular may be interpreted in the singular or plural unless an explicit expression such as “one” or “single” is used.

In the following description, regardless of the drawing, the same drawing number refers to the same constituent element, and “and/or” includes all combinations of each and at least one of the constituent elements mentioned.

In the example flowcharts described with reference to the drawings, the operation order may be changed, various operations may be merged, certain operations may be divided, and certain operations may not be executed.

In case of an internet protocol (IP) filter, which is an example of IP security, there is an inconvenience in that an administrator must specify a filtering target IP address. In addition, when the IP address of an image forming device is changed or a network is changed in accordance with movement of the image forming device, the IP filtering policy for the image forming device is changed, and thus it is necessary to set again.

According to an example, a server receives an IP address request packet of a device to be connected to the network and allocates an IP address, and transmits IP security policy information together with IP address information. The image forming device searches for a server and requests IP address allocation, and receives an IP security policy together with an IP address and sets the received IP security policy information.

Hereinafter, examples will be described with reference to the accompanying drawings.

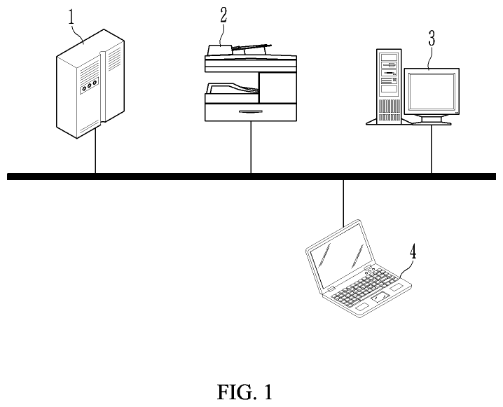

FIG. 1 is a block diagram of a network according to an example.

Referring to FIG. 1, a server 1, an image forming device 2, and user devices such as personal computers (PCs) 3 and 4 are connected through a network.

When receiving an IP address request packet of equipment to be connected to the network, the server 1 may allocate an IP address and transmit IP security policy information and IP address information.

As an example of the server 1, a dynamic host configuration protocol (DHCP) server may be used. The DHCP server 1 receives a DHCP server discovery message by opening user datagram protocol (UDP) port 67, and broadcasts the received message using a DHCP server suggestion message to all clients of the network. When receiving an IP address request packet from a DHCP client, the DHCP server 1 dynamically allocates an IP address to the corresponding client and transmits IP security policy information together with the IP address information when allocating the IP address. The DHCP server 1 includes a database in which IP address list information and IP security policy information to be allocated to equipment to be connected to the network are stored. In an example, and Domain Name System (DNS) server information, Windows Internet Name Service (WINS) server information, or the like may be additionally stored in the database of the DHCP server 1.

The image forming device 2 is provided with a wired or wireless interface, and is connected to the network through the interface. The image forming device 2 executes a client function with respect to the server 1, and thus, when an IP address is not allocated to the image forming device 2, the image forming device 2 transmits an IP address request packet to the server 1 which allocates an IP address, and may receive IP address information and IP security policy information when the IP address is allocated.

When the server 1 is implemented as a DHCP server, the image forming device 2 executes a DHCP client function, and thus when an IP address is allocated to the image forming device 2, the image forming device 2 transmits a DHCP server discovery message (port 67, UDP passage) to all nodes connected to the network. After the transmission, the image forming device 2 discovers a DHCP server according to a DHCP server suggestion message, allocates an IP address by transmitting an IP address request packet to the corresponding DHCP server, and receives IP address information and IP security policy information when the IP address is allocated. When a plurality of DHCP servers are discovered, one of the discovered DHCP servers may be selected.

The image forming device 2 may also request IP security policy information from the server 1 together with the IP address request packet. When receiving the IP security policy information, the image forming device 2 may dynamically enable an IP security policy function and automatically set the corresponding IP security policy information.

The user PCs 3 and 4 are examples that can be connected to the network, and the user PC 3 may be a computer or mobile information device with an IP address licensed by the network's security policy and the user PC4 may be a computer or a mobile information device with an IP address not authorized by the security policy of the network.

Hereinafter, an image forming device according to an example will be described.

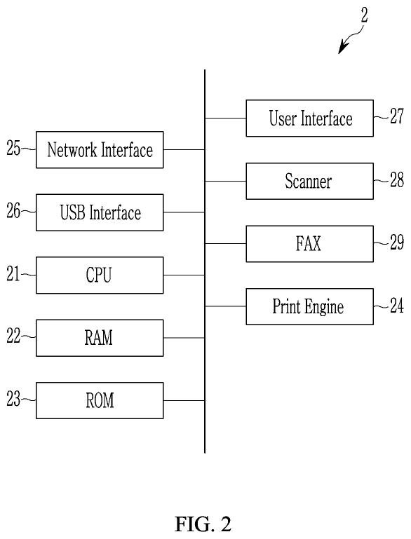

FIG. 2 is a block diagram of an image forming device according to an example.

Referring to FIG. 2, the image forming device 2 includes a central processing unit (CPU) 21, a random access memory (RAM) 22, a read only memory (ROM) 23, a print engine 24, a network interface 25, a universal serial bus (USB) interface 26, a user interface 27, a scanner 28, and a facsimile (FAX) 29. The block diagram of the image forming device 2 shown in FIG. 2 is an example for description of the image forming device 2, and the image forming device 2 is not limited thereto. At least one element may not be included or additional elements may be further included.

The CPU 21 is provided for controlling the image forming device 2, and drives and executes software for controlling an operation of the image forming device 2. For example, when receiving IP address information and IP security policy information from the server 1, the CPU 21 drives and executes software processing the corresponding information.

The RAM 22 is a volatile storage device of the image forming device 2 and provides a working memory for operation of programs of the image forming device 2. The RAM 22 may provide a memory space for temporarily storing data.

The ROM 23 is a nonvolatile storage device 2 of the image forming device 2, and stores firmware in which various pieces of software required for operation of the image forming device 2, IP security policy information, or the like are implemented. Among the various pieces of software, at least one piece of software may include instructions for receiving IP address information and IP security policy information.

The print engine 24 is a hardware device that executes a printing function of the image forming device 2.

The network interface 25 is hardware that executes wired or wireless network communication. The wireless network communication may follow the institute of electrical and electronics engineers (IEEE) 802.3 standard, and can support transmitting/receiving speeds such as 10/100/1000 Mbps. Hardware of the network interface 25 may include a physical layer, a chip, an Ethernet controller, or the like. An IP address request packet can be transmitted to the server through the network interface 25, and a response packet transmitted from the server 1 can be received through the network interface 25.

The USB interface 26 follows the USB communication standard, and transmits/receives data and a control signal to/from an external device.

The user interface 27 may be formed of a graphical touch user interface (UI), a two-line liquid crystal dislay (LCD), a four-line LCD, a light emitting diode (LED), an organic LED (OLED), or the like depending on types of the image forming device 2.

The scanner 28 is a hardware device that converts a hard copy to a soft copy.

The FAX 29 is a hardware device that transmits/receives a document image through a telephone line.

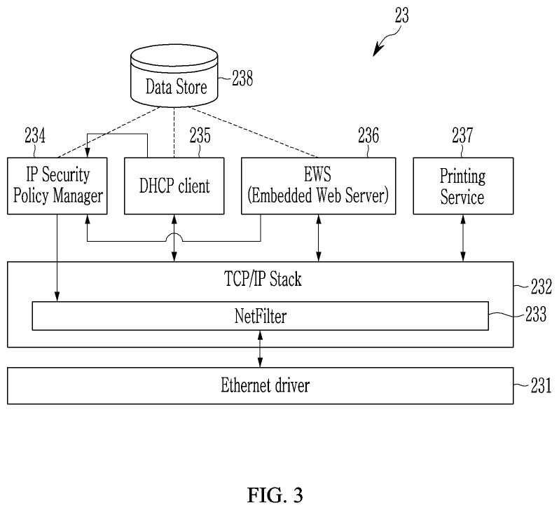

FIG. 3 is a block diagram of a software function module of an image forming device according to an example.

Referring to FIG. 3, the software of the image forming device 2 may be stored in the ROM 23. The software stored in the ROM 23 includes an Ethernet driver module 231, a transmission control protocol/internet protocol (TPC/IP) stack module 232, a netfilter module 233, an IP security policy administrator module 234, a DHCP client module 235, an embedded web server (EWS) module 236, a printing service module 237, and a data store module 238 depending on each function. As shown in FIG. 3, the software of the image forming device 2 may be classified into function modules, but is not limited thereto. Also, additional function modules may be further included.

The Ethernet driver module 231 is a network transmitting/receiving module that controls an Ethernet controller of the network interface 25 to receive a network packet from the outside and transmit the received packet to a TCP/IP stack module 232 through the netfilter module 232, or receives a network packet transmitted from the TCP/IP stack module 232 and transmits the received packet to the outside.

The TCP/IP stack module 232 is a software module that implements a TCP/IP network protocol stack and implements basic protocols (e.g., TCP, user datagram protocol (UDP), IP, internet control message protocol (ICMP), address resolution protocol (ARP), or the like) for network communication between devices, and may usually be located inside an operating system (OS).

The netfilter module 233 filters an externally received packet in accordance with a predetermined IP policy. The netfilter module 233 discards packets not allowed by the IP security policy, and passes allowed packets.

The printing service module 237 is a server software module that receives printing data. For example, the printing service module 237 opens TCP port 9100 and receives printing data transmitted from a remote PC, and transmits the received data to the print engine 24.

The EWS module 236 receives and processes a hyper text transfer protocol (HTTP) request transmitted from an external web client or web browser, and transmits an HTTP response. For example, the EWS module 236 opens TCP 80 port or TCP 431 port, and receives the HTTP request.

The HTTP request received at the EWS module 236 is processed according to a URL, and when the received HTTP request is the present IP security policy information request set in the image forming device 2, the EWS module 236 reads the IP security policy setting information stored in the data store module 238 to respond to the request with the corresponding information. When the HTTP request is a new IP security policy setting request, the EWS module 236 receives new IP security policy information and transmits the new IP security policy information to the IP security policy administrator module 234, and stores the information in the data store module 238.

The DHCP client module 235 is a module that implements DHCP to perform as a client with respect to the DHCP server 1. When the DHCP function of the image forming device 2 is enabled and an IP address is not allocated, the DHCP client module 235 discovers the DHCP server 1, requests IP address allocation from the DHCP server 1, and sets a new IP address in the image forming device 1 by being allocated with the new IP address from the DHCP server 1. In this case, the DHCP client module 235 receives IP security policy information together with the IP address and transmits the IP security policy information to the IP security policy administrator module 234, and the IP security policy administrator module 234 stores the IP security policy information in the data store module 238.

The IP security policy administrator module 234 is a module that sets, stores, and manages an IP security policy. The IP security policy administrator module 234 reads the IP security policy stored in the data store module 238 and sets a policy in the netfilter module 232, and receives a new IP security policy received at the DHCP client module 235 or the EWS module 236 to store in the data store module 238 and set in the netfilter module 233.

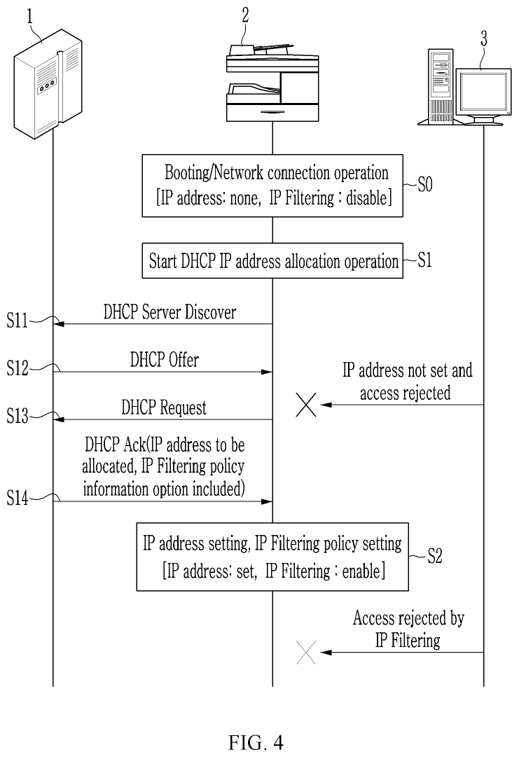

Hereinafter, referring to FIG. 4, an example operation for setting an IP security policy in an image forming device will be described. In FIG. 4, an IP filtering method in which filtering is performed based on an IP address, as an example of an IP security method, is illustrated.

The IP filtering is a method for allowing or blocking a packet received based on an IP address of a network packet that the image forming device 2 receives from a network. In terms of network security, packets that are not allowed can be basically blocked. In order to operate the IP filtering, an IP security policy that decides an IP address to be allowed or blocked is required, and the image forming device 2 sets and stores an IP security policy received from the server 1.

The IP security policy may include a method (hereinafter referred to as an IP security method) for transmitting/receiving data through encryption with respect to a specific IP address among IP addresses, in addition to the IP filtering method. The IP security method is a method for encrypting data to protect data between receiving places and destinations at an IP layer using a network standard protocol. For example, data is encrypted when communication is carried out with a device corresponding to a specific IP address and the encrypted data is transmitted and received.

The IP security policy may be implemented in various ways and is not limited to the example IP filtering method and the IP security method as described. IP security policy information is set in the server 1 according to a security policy of the corresponding network. For example, IP filtering information or IP security information is set in the DHCP server 1 according to a security policy of the corresponding network. The above-stated setting can be carried out by the administrator.

FIG. 4 is a flowchart of an IP security policy setting process according to an example.

Referring to FIG. 4, an example will be described in which the image forming device 2 is newly connected with the network.

At initial booting of the image forming device 2, the image forming device 2 is in a default state and no IP address is allocated. In that case, IP filtering, which is one of IP security policies, is in a disable state in operation SO.

The DHCP client module 235 of the image forming device 2 operates to set an IP address of the image forming device 2 such that DHCP IP address allocation is started between the image forming device 2 and the server (e.g., a DHCP server) in operation S1.

The DHCP IP address allocation operation S1 includes discovery operation S11 during which a broadcast packet is transmitted to search for the DHCP server 1, provision operation S12 during which a response is received from the DHCP server 1, IP address allocation request operation S13, and an operation for receiving an IP address from the DHCP server 1.

In operation S11, the image forming device 2 executes the operation for discovering a DHCP server 1 connected with a network. For example, the image forming device 2 designates the UDP port 67 as a designation portion and broadcasts a DHCP server discovery message.

The DHCP server 1 receives the DHCP server discovery message that was broadcast in operation S11, and broadcasts a DHCP server offer message to all clients in operation S12.

The image forming device 2 receives the DHCP server offer message that was broadcast in operation S12, and transmits a DHCP request message, that is, an IP address request packet, to the DHCP server 1 in operation S13. In this case, the image forming device 2 transmits an IP filtering policy information request packet to the DHCP server 1, together with the IP address request packet.

The DHCP server 1 receives the DHCP request message that was transmitted in operation S13, and transmits a DHCP response message (DHCP ACK) that includes an IP address to be allocated to the image forming device 2 and the IP filtering policy information in operation S14. The IP filtering policy information may be included in an option of the IP protocol.

The image forming device 2 sets a network security policy based on the IP address and the IP security policy. For example, the image forming device 2 sets an IP address, and sets the network security policy according to IP filtering policy information in operation S2. Then, the IP filtering is in an enable state.

When the user PC 3 connected to the network other than the image forming device 2 is unlicensed equipment, an IP address cannot be allocated from the DHCP server 1 such that the user PC 3 cannot access the image forming device 2 and the DHCP server 1. Access of the user PC 3 to the image forming device 2 is blocked by IP filtering of the image forming device 2.

In FIG. 4, a DHCP protocol may be used for the DHCP server 1 to dynamically automatically allocate an IP address of a device that is newly connected to the network. When the DHCP server allocates an IP address to a client device, other network setting information such as a DNS server or the like may be transmitted together with the IP address by using an option setting.

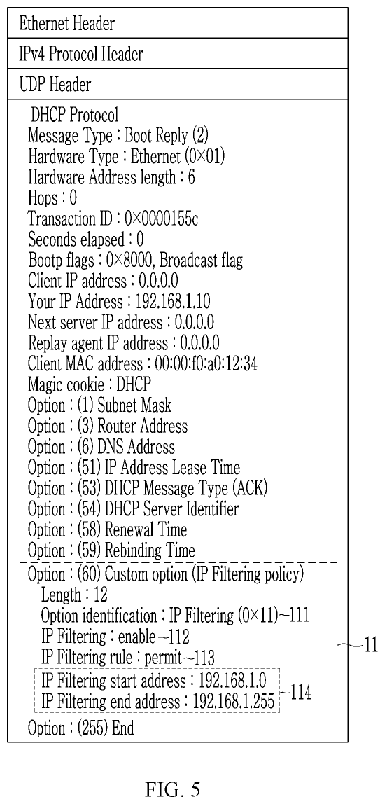

FIG. 5 shows a packet of a response message of a DHCP server according to an example.

Referring to FIG. 5, an IP protocol of the DHCP server 1 according to an example defines IP filtering setting information that is not included in an existing standard option definition and transmits the defined IP filtering setting information by including the same in a custom option field 11, together with the allocated IP address. The custom option field 11 in the DHCP protocol is an area licensed by a standard request for comments (RFC) which a vendor can specifically define. The custom option field 11 may include custom identification that indicates IP security policy setting and information related to an IP security policy to be set.

For example, in the DHCP server response packet, Option (60) field is a custom option field 11 that is newly defined to transmit information on the IP security policy, and at least one of identification information 111 (Option identification: IP filtering) that instructs an IP filtering policy among the IP security policy, setting information 112 (IP Filtering: enable) that indicates whether the corresponding IP security policy (e.g., IP Filtering in FIG. 5) is enabled or disabled, information 113 (IP Filtering rule: permit) that indicates whether an IP filter rule is permitted or rejected, and address area information 114 (IP Filtering start/end address) that indicates an address area to which IP Filtering is applied may be included in the custom option field 11.

When the IP filtering rule is permitted, IP addresses written in the address area information 114 become permission targets, and IP addresses not written in the address area information 114 become rejection targets. When the IP filtering rule is rejected, addresses written in the address area information 114 become rejection targets, and IP addresses not written in the address area information 114 become permission targets.

When the image forming device 2 sets an IP security policy according to the DHCP server response packet shown in FIG. 5, access of a device corresponding to the IP address areas 192.168.1.0 to 192.168.1.255 is allowed and access of a device that does not correspond to the IP address areas 192.168.1.0 to 192.168.1.255 is blocked.

In FIG. 5, fields other than the field Option (60) are the same as the existing DHCP packet in the block diagram, and accordingly, a detailed description will be omitted.

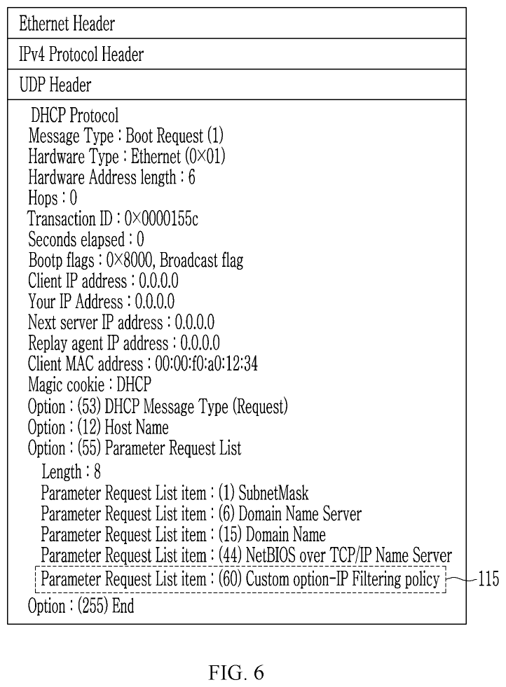

FIG. 6 shows a packet of a DHCP request message of an image forming device according to an example.

Referring to FIG. 6, in a DHCP request message packet, a field 115 that requests an IP filter policy (IP Filtering policy) may be added to a custom field of Option (60) in a field Option (55), which is a parameter request list (Parameter Request list item). That is, IP filtering policy information of the IP security policy may be requested together with the IP address allocation request from the DHCP server 1.

Referring again to operation S14 in FIG. 4, when the image forming device 2 receives the DHCP IP address allocation packet and the IP filtering setting information transmitted from the DHCP server 1, the DHCP client module 235 of the image forming device 2 extracts the IP filtering information and transmits the extracted information to the IP security policy administrator module 234.

The IP security policy administrator module 234 sets the IP filtering function to be enabled according to the received IP filtering policy information, sets an allowed IP address range of a netfilter module 233 according to a predetermined value, and stores the allowed IP address range in a data store module 238. Alternatively, when a rejected IP address range is set in the IP filtering policy information, the IP security policy administrator module 234 sets the IP filtering function to be enabled according to the received IP filtering policy information, sets a rejected IP address range of the netfilter module 233 according to a predetermined value, and stores the rejected IP address range in the data store module 238.

Thus, the IP security policy can be automatically set to receive (or block) only an address of a specific IP address range according to a security policy of a network to which the image forming device 2 is connected, thereby easily reinforcing security. In addition, when an IP address is changed due to movement of the image forming device 2 or a change of a network connected with the image forming device 2, IP security policy setting can be automatically changed together with an IP address without manual IP security setting by an administrator.

Further, when the network of the image forming device 2 is disconnected or IP address acquisition from the DHCP server 1 is failed or the image forming device 2 moves to another network where no security policy is set after the IP filtering is enabled in the image forming device 2, the IP filtering setting of the image forming device is automatically disabled to thereby reduce unnecessary setting errors.

The IP security policy may be an IP security method.

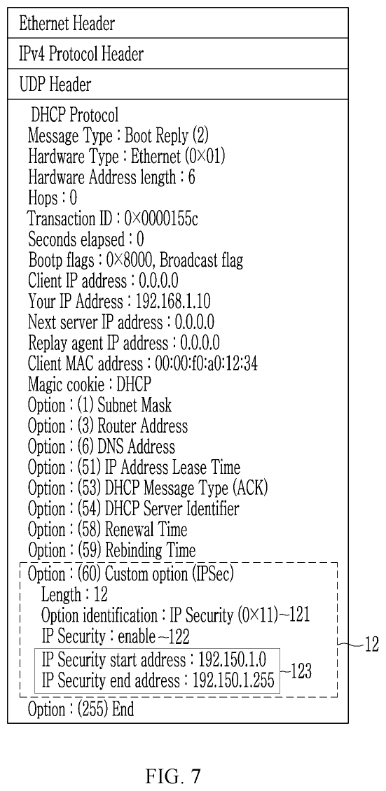

FIG. 7 shows a packet of a response message of a DHCP server to which an IP security method is applied according to an example.

Referring to FIG. 7, a custom option field 12 of a DHCP server response packet may include at least one of identification information 121 (Option identification: IP security) that instructs an IP security policy in the IP security policy, setting information 122 (IP Security: enable) that relates to whether or not a corresponding IP security policy (IP security in FIG. 7) is enabled or disabled, and address area information 123 (IP Security start/end address) that informs an address area to which IP security is applied.

When the IP security policy is set in the image forming device 2 according to the DHCP server response packet shown in FIG. 7, data communicated with a device included in IP address areas 192.150.1.0 to 192.150.1.255 is encrypted and encrypted data is transmitted/received.

Hereinabove, an example has been described in which the image forming device 2 receives IP address allocation and IP security policy information from the server 1, sets an IP security policy, and stores the IP security policy. Hereinafter, an example in which the image forming device 2 manages an IP address according to an IP security policy will be described.

Conventionally, only an administrator who manages an image forming device is allowed to set an IP address according to an IP security policy. For example, in IP filtering, an IP address to be permitted or rejected is set by the administrator. In this case, when a PC that uses a new IP address needs to use an image forming device, the administrator checks an IP address of new PCs one by one and adds an IP address to be permitted in the IP filtering.

However, in the image forming device 2 according to an example, a configuration for a user of a new IP address to request permission of the new IP address from the image forming device 2 is added.

The image forming device 2 constructs a database related to an IP address (White List) to receive, an IP address to be blocked (Black List), and an indeterminate IP address (Gray List), and when access from an IP address included in the gray list is received, access only to an IP filtering release request page of an EWS module 236 of the image forming device 2 is allowed and other network ports are blocked. An example will be illustrated in which a permission request with respect to a new IP address is available through the EWS module 236. However, in other examples, an additional configuration may be provided in the image forming device 2 and a permission request and a process with respect to a new IP address can be carried out through the corresponding configuration.

The white list, the black list, and the gray list may be constructed as databases in firmware of the ROM 23 of the image forming device 2.

The EWS module 236 redirects the IP filtering release request page to a device that corresponds to a new IP, for example, a new PC. An IP user of the new PC may request unblocking of the new IP address from a web page of the EWS 236 of the image forming device 2 directly through the redirected IP filtering release request page. When an administrator of the image forming device 2 acknowledges the requested IP unblock request and allows the corresponding IP address, the corresponding IP address moves to the white list of the image forming device 2. Then, access to the image forming device 2 from the corresponding IP address can be established.

In addition, the IP unblock request page may further include a function to request the IP address unblocking for only a predetermined time period. A temporary user specifies and inputs a duration of access time through the IP unblock request page, and the administrator of the image forming device 2 allows access to the corresponding IP address only during the input predetermined time period. That is, the corresponding IP address is included in the white list of the image forming device 2 only during the input predetermined time period.

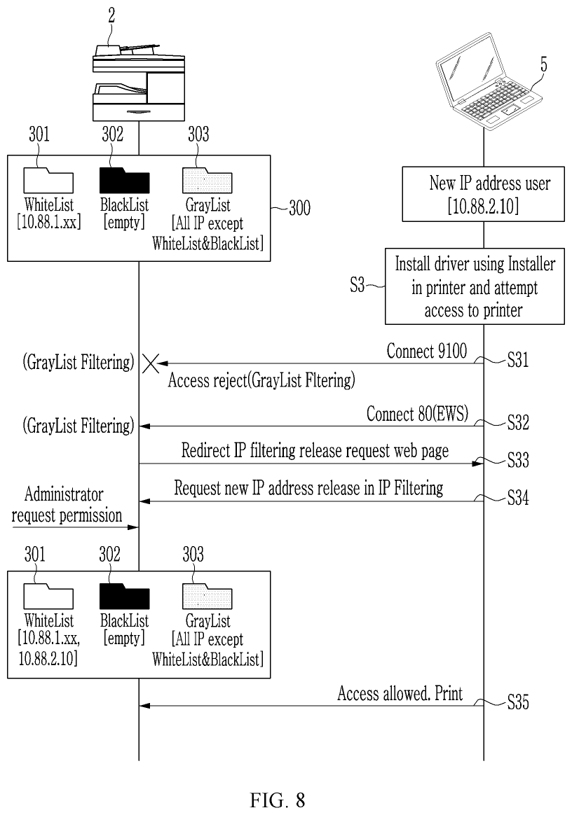

FIG. 8 is a flowchart illustrating an IP security policy management method of an image forming device according to an example.

In the following example, FIG. 8 illustrates a method for adding an IP address of a new device in the IP filtering of the IP security policy. In FIG. 8, a new PC is illustrated as an example of the new device, but the present invention is not limited thereto.

Referring to FIG. 8, an IP filtering database 300 may be provided in the ROM 23. The database 300 includes a white list 301, which is a receiving permitted IP address list, a black list 302, which is a receiving rejected IP address list, and a gray list 303, which is an undecided IP address list that allows permission requests. The gray list 303 may include other IP addresses that are not included in the white list 301 or the black list 302.

The image forming device 2 allows receiving when a packet is received from an IP address included in the white list 301, and rejects receiving when a packet is received from an IP address included in the black list 302. It will be described that a new PC 5 is connected with a new IP address [10.88.2.10] to the network, and the IP address of the new PC 5 is not included in the white list 301 or the black list 302.

The new PC 5 attempts access to the image forming device 2 after installing a driver using an installer of the image forming device 2 in operation S3. The new PC 5 attempts access through TCP port 9100.

Since the IP address of the new PC 5 is not included in either the white list 301 or the black list 302, the IP address is classified into the gray list 303. Since the IP address of the device accessing the image forming device 2 is included in the gray list 303, the image forming device 2 rejects access according to gray list filtering in operation S31.

According to the gray list filtering, the image forming device 2 allows access only to an IP filtering release request page with respect to a packet received from the IP address of the new PC 5 in operation S32. That is, the new PC 5 accesses only TCP port 80 of the EWS module 236.

The EWS module 236 redirects the IP filtering release request page to the IP address of the new PC 5 in operation S33. The IP filtering release request page may provide an input window through which a permission request IP address, user information, a permission period, or the like can be input.

The user of the new PC 5 requests release of the IP address of the new PC 5 in the IP filtering through the IP filtering release request page in operation S34. In this case, the IP address, the user information, the permission period, or the like of the new PC 5 can be received at the EWS 236.

Information input from the user of the new PC 5 is transmitted to an administrator terminal of the image forming device 2, and the administrator accesses a management page of the EWS module 236 of the image forming device 2 through a management terminal to determine and set whether or not the request is accepted. When the request is accepted, the corresponding IP address is included and maintained in the white list 301 during an allowed permission period, and is included back to the gray list 303 when the permission period is terminated. As shown in FIG. 8, IP address [10.88.2.10] is included in the white list 301 such that the new PC 5 accesses the image forming device 2 and thus printing can be available in operation S35.

Through the above described examples, IP security policy can be automatically set for an image forming device without the involvement of an administrator, thereby improving usability of the image forming device and enhancing network security.

For example, when allocating a DHCP IP address of an image forming device, a security policy may be automatically set to the image forming device so that only an IP address of a specific IP address area may be received according to the security policy of the corresponding network. For example, an IP filtering function can be automatically enabled in the image forming device such that security of the image forming device can be reinforced. In addition, when the IP address of the image forming device is changed according to a location movement of the image forming device or a connected network change, the IP security policy setting can be dynamically changed together without manual security policy setting of an administrator, thereby reinforcing usability and security.

In addition, when an addition or modification occurs in the IP security policy of the image forming device with respect to the new IP address, a user of the new IP address can request IP address unblocking from the image forming device and set an allowable period of a new IP address to be permitted, thereby dynamically managing the IP security policy of the image forming device more easily.

The examples described above may be implemented not only through methods and apparatuses, but may be implemented through a program for realizing a function corresponding to the configuration of the examples or a recording medium on which the program is recorded.

Although examples have been described above, the present invention is not limited thereto, and the present invention may be modified in various ways within the scope of the claims and the detailed description and accompanying drawings of the invention, which falls within the scope of the present invention.

What is claimed is:

1. A network security setting method comprising:
receiving a server discovery message;
broadcasting a server offer message in response to the server discovery message;
receiving an internet protocol (IP) address allocation request from an image forming device that has received the server offer message; and
transmitting an IP address and an IP security policy to the image forming device in response to the IP address allocation request.

2. The network security setting method of claim 1,
wherein a packet that includes the IP address and the IP security policy comprises a field to transmit information of the IP security policy, and
wherein the field comprises at least one of:
identification information that indicates the IP security policy,
setting information with respect to whether or not to apply the IP security policy, or
address area information to which the IP security policy is applied.

3. The network security setting method of claim 2, wherein, when the IP security policy is IP filtering, the field further comprises information that indicates whether a rule of the IP filtering is permission or rejection.

4. A network security setting method of an image forming device that is connected to a network, the method comprising:
discovering a server in the network;
requesting an internet protocol (IP) address from the discovered server;
receiving an IP address and an IP security policy from the discovered server; and
setting a network security policy based on the received IP address and IP security policy.

5. The network security setting method of claim 4, wherein the discovering of the server comprises:
designating a destination portion and broadcasting a server discovery message by the image forming device; and
receiving a server offer message in response to the server discovery message.

6. The network security setting method of claim 4, wherein the requesting of the IP address comprises transmitting an IP address request packet to the discovered server by the image forming device.

7. The network security setting method of claim 6, wherein the requesting of the IP address further comprises transmitting an IP security policy information request packet together with the IP address request packet by the image forming device.

8. The network security setting method of claim 4,
wherein the setting of the IP security policy comprises setting the network security policy according to the IP security policy information received from the discovered server, and
wherein the field comprises at least one of:
identification information that indicates the IP security policy,
setting information that informs whether or not to apply the IP security policy, or
address area information to which the IP security policy is applied.

9. The network security setting method of claim 8, wherein, when the IP security policy is IP filtering, the field further comprises whether a rule of the IP filtering is permission or rejection.

10. The network security setting method of claim 4, further comprising:
allowing access only to an IP filtering release request page with respect to a packet received from an IP address of a new device; and
redirecting an IP filtering release request page to the IP address of the new device.

11. An image forming device comprising:
a memory that includes software required to operate an image forming device; and
a processor to drive and to execute the software stored in the memory,
wherein the software comprises:
a client module to discover a server in a network to which the image forming device is connected, request an IP address from the discovered server, and receive an IP address and an IP security policy from the discovered server, and
an IP security policy administrator module to set the received IP address and IP security policy.

12. The image forming device of claim 11, wherein the software further comprises an embedded web server (EWS) module to process a permission request with respect to an IP address of a new device, which will be connected to the network.

13. The image forming device of claim 12, wherein the EWS module is further to redirect an IP filtering release request page to the IP address of the new device, and transmit information received from the IP address to an administrator terminal.

14. The image forming device of claim 12, wherein the memory comprises at least one of a white list, which is a receiving permitted IP address list, a black list, which is a receiving rejected IP address list, or a gray list, which is a list of IP addresses that are included neither in the black list nor in the white list.

15. The image forming device of claim 11, wherein the software comprises at least one of:
a netfilter module to filter the received data packet according to the IP security policy; or
a data store module to store the received IP security policy.
